(19) United States
(12) Patent Application Publication
(10) Pub. No.: US 2003/0094127 A1
(43) Pub. Date: May 22, 2003

(54) Distress signalling

(76) Inventor: John J. Stelmach, Prescott, AZ (US)

Correspondence Address: Charles E. Cates, Cates & Holloway, P.O. Box 1532, Scottsdale, AZ, 85252-1532, US

(21) Appl. No.: 10/043,705

(22) Filed: Nov. 21, 2001

(51) Int. Cl. G08B 1/00

(52) U.S. Cl. 116/211; 116/209

(57) ABSTRACT

A highly effective method and means for stranded or disabled persons to display visible distress signals that can be seen by search and rescue teams from a distance. The invention is achieved by providing, as part of the stranded person's equipment, a kit containing multiple particles of glitter material capable of reflecting sun rays or the rays from search lights. In use, the stranded person spreads or broadcasts the glitter material on the ground or in shrubs or trees in the surrounding environment. Since the broadcast material provides a myriad of facets focused in every conceivable direction to catch the rays of the sun or the rays from searchlights, it acts as a highly visible signal without the need for the stranded person to be aware of rescuers or to actively focus anything in the direction of the rescuers.

### BACKGROUND OF THE INVENTION

This invention relates to methods and means for stranded or disabled persons to display visible distress signals that can be seen by search and rescue teams from a distance.

When persons such as injured or lost hikers or passengers in downed aircraft or victims of water accidents become stranded in inaccessible locations, and are the subject of search and rescue operations, an important factor in locating them is their ability to set up some kind of distress signal that can attract the attention of the rescue teams. Known signaling devices such as cell phones, flares, dyes (for water situations), and the like are either too bulky or cumbersome to be a convenient part of a back pack or emergency kit or are not operable under all conditions. For example, although a mirror is lightweight and is capable of signaling under certain conditions, it has its drawbacks because the distressed person must be aware of an overhead aircraft or a distant searcher, so that the mirror can be focused to reflect sunlight in the direction of the searcher. If the stranded person becomes unconscious or for some other reason does not notice the searchers, the mirror is not effective. Also, mirrors are dependent on sunlight and are not useful in the dark of night.

There is a need for a signaling system that is lightweight and convenient for carrying in the usual backpack or emergency kit and that provides a highly visible signal under daytime or nighttime conditions, and without the need for the stranded person to be constantly on alert for rescuers in the vicinity.

### SUMMARY AND OBJECTS OF THE INVENTION

It is therefore an object of the present invention to provide a method of displaying a distress signal that is readily visible from the air or from distant locations in both sunlight and dark, and without the need for the stranded person to be aware of the presence of rescuers or the requirement that the person focus rays of light in the direction of rescuers.

It is another object of the invention to provide a method utilizing portable, lightweight components that can readily be included in a simple backpack or emergency kit.

It is still another object to provide a lightweight kit containing the display materials in a form that can readily be activated, regardless of whether the person is stranded on land or water.

Other objects and a fuller understanding of the invention will become apparent as the specification proceeds.

In accordance with the invention as embodied and broadly described herein, the foregoing and other objects are achieved by providing, as part of the stranded person's equipment, a kit containing multiple particles of glitter material capable of reflecting sun rays or the rays from search lights. In one embodiment, the invention comprises the step in which the stranded person spreads or broadcasts the glitter material on the ground or in shrubs or trees in the surrounding environment. Since the broadcast material provides a myriad of facets focused in every conceivable direction to catch the rays of the sun or the rays from searchlights, it acts as a highly visible signal without the need for the stranded person to be aware of rescuers and without the need to actively focus anything in the direction of the rescuers.

In a specific embodiment of the invention, the glitter material may take the form of fragments or an elongated streamer of plastic sheet material coated with flakes of glitter or other reflective surface coating material and bonded to a cellular backing sheet such as polyurethane foam. The cellular backing material on the plastic sheet fragments enhances the ability of the fragments to be caught and displayed on trees or shrubs in the vicinity, as well as the ability to float on water in the event a water accident is involved. In the case of a streamer, the backing should be flexible to permit movement in a breeze.

### BRIEF DESCRIPTION OF THE DRAWINGS

In order to more fully understand the manner in which the above-recited and other advantages and objects of the invention are obtained, a more particular description of the invention will be rendered by reference to specific embodiments thereof which are illustrated in the appended drawings. Understanding that these drawings depict only typical embodiments of the invention and are not therefore to be considered to be limiting in scope, the invention in its presently understood best mode for making and using the same will be described and explained with additional specificity and detail through the use of the accompanying drawings in which:

FIG. 1 is a perspective view showing the invention in use.

FIG. 2 is a cross-sectional view of the base sheet from which the glitter materials of the present invention are made.

FIG. 2A is a cross-sectional view showing glitter applied to both sides of the base sheet.

FIG. 3 is a cross-sectional view of the base sheet, showing an added flotation layer made from a cellular material.

FIG. 4 illustrates the backing layer in irregular shapes.

FIG. 5 shows an elongate streamer made of flexible plastic, carrying flakes of glitter on both sides.

FIG. 6 shows the streamer of FIG. 5 rolled up for transport and storage.

### DESCRIPTION OF THE PREFERRED EMBODIMENTS OF THE INVENTION

As illustrated in FIG. 1, the invention is a method for use by a person in a distress situation to attract the attention of rescuers, comprising the step of spreading in the surrounding environment multiple particles of glitter material capable of reflecting sun rays or the rays from searchlights. In FIG. 1, the stranded person 10 has broken open a bag 11 and has broadcast its contents of glitter material 12 over the ground 13 and a neighboring bush 14 in the surrounding environment. With this random distribution, there is a reflecting facet from the glitter material in every direction.

If a water accident is involved, and the person is stranded in a boat or raft, the glitter material can be broadcast over the visible portions of the boat or raft and on the surrounding water. If on a river or other stream of water with a current, the floatable glitter material will provide a surface trail which can be followed by rescuers to reach the downstream location of the stranded person. If the accident occurs in a cave in a spelunking operation, the stranded person may broadcast the glitter material on the surrounding walls and floors, so that the rays of searchlights will be caught and observed.

The bag or envelope 11 may be made of any suitable material, preferably a transparent plastic material such as vinyl or Mylar. It serves as the lightweight carrier for the lightweight glitter material 12 in the back pack or emergency kit carried by the person involved. Instead of a bag or envelope, the carrier for the glitter material may take the form of a lightweight plastic tube, from which the glitter may be expelled with a plunger.

The glitter material 12 may be multiple fragments, flakes, chips or sequins that are lightweight and provide an effective light reflective surface. A preferred embodiment of a glitter material comprises fragments of a lightweight sheet of plastic having bonded to at least one surface a quantity of “glitter.” The term “glitter” ordinarily connotes small reflective flakes or particles, which may be of consistent or varying size and shape, and which are commercially available from such companies as 3M of Minneapolis, Minn., using a wide variety of technologies. For example, such glitter particles may include mica, pearl mica, glass flake, aluminum powder, stainless powder, brass powder, metallic plating powder, metallic coating powder, aluminum flake, aluminum foil, zinc, and bronze powder.

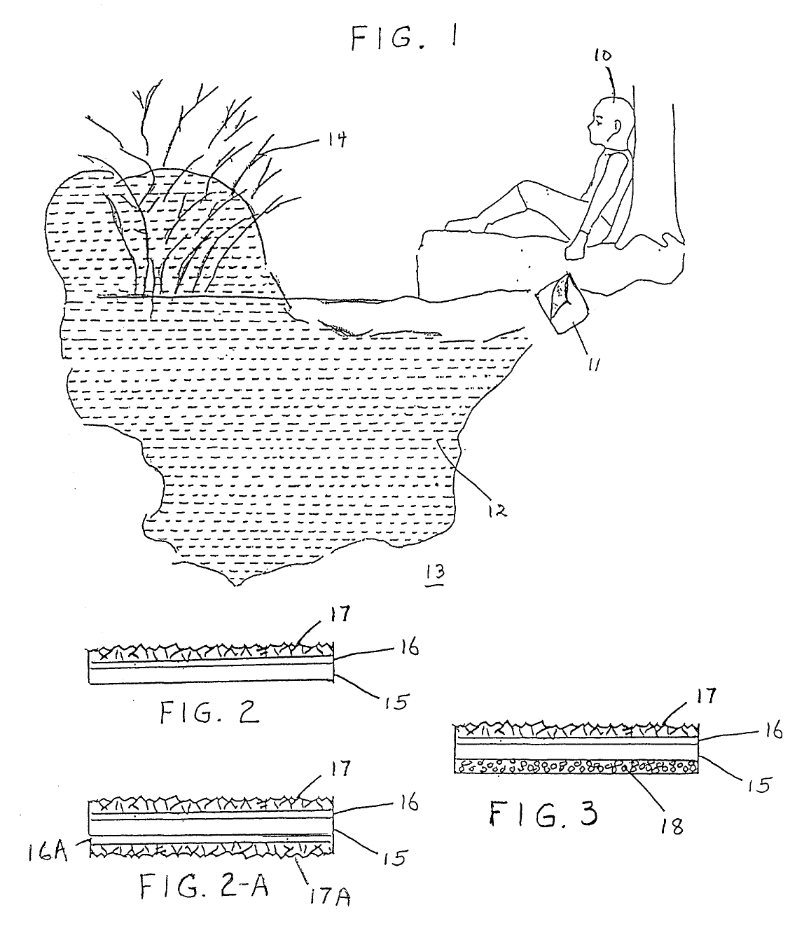

FIG. 2 shows a cross-section of a plastic sheet that may be coated with glitter and then cut into fragments, flakes or chips to form the glitter material 12 of the present invention. In the embodiment shown in FIG. 2, the base sheet 15 may be any suitable plastic, such as polymer film, paper, cellophane, foil, and the like. In producing the product, a layer of adhesive or other bonding material 16 is applied to at least one surface of the base sheet 15, and then the glitter 17 is applied to the adhesive surface by any known means, including sprinkling or spraying, depending on the character and size of the glitter particles. Finally, the product is cured and then cut into small fragments, chips or flakes for use in the invention. If desired, both sides of the base sheet 15 may be provided with a bonded layer of glitter, as shown in FIG. 2A, wherein a second bonding layer 16A and a second glitter layer 17A are applied. The fragments, flakes or chips that are cut from the thus treated base sheet 15 may be any desired shape, such as square, rectangular, triangular, round, etc. and may be of such size as will permit the small plastic container 11 to carry at least thousands of such flakes. In one embodiment, as shown in FIG. 4, the fragments may be cut with jagged side edges 19 that will assist the fragments to be caught in the foliage of nearby trees and shrubbery and held there for greater periods of time.

The invention also contemplates the use of other techniques for providing or enhancing the reflectivity of the base sheet 15, such as, for example, coating the base sheet with a pearlescent paint instead of applying the layer of glitter material 17, or embossing the base sheet 15 after the glitter layer 17 has been applied.

In a further embodiment, as shown in FIG. 3, the base sheet 15 may be provided with a bonded cellular layer 18 made from a material such as sponge or polyurethane foam. Fragments made from the sheet of FIG. 3 have the advantage of clinging to shrubbery or trees for greater periods of time, or of floating on water, in the event a water accident is involved.

A still further embodiment contemplates the use of a glitter material 12 which is made up of reflective flakes made of metal or other materials that are self-supporting in and of themselves, such as aluminum foil or various metal alloys such as aluminum magnesium, and that do not require the use of a base sheet 15, but nevertheless can be cut into small fragments to provide the myriad of reflective particles contemplated by the present invention and which can be bonded to a floatable backing material, such as 18, while in sheet form and then cut into the small fragments, flakes or chips useful in the present invention. As with the fragments of base sheet 15, it is preferred that the fragments of self-supporting metal foil be cut with jagged or serrated edges that will assist in clinging to surrounding foliage or surfaces.

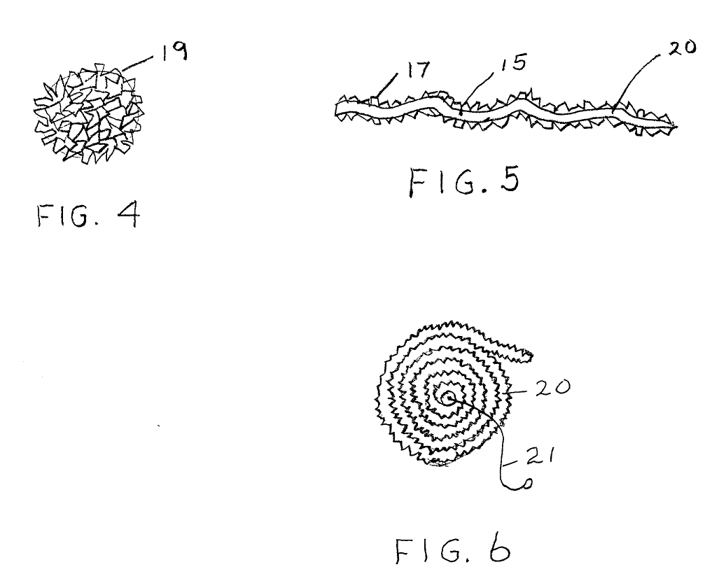

Yet another embodiment is shown in FIGS. 5 and 6, wherein the substrate 15 is Mylar in the form of a streamer 20 that is ten feet long, or other useful length, rolled up for storage and transport until ready for use. When ready, a lanyard 21 that is attached to an end of the streamer 20, in the middle of the roll, may be pulled to release the streamer. Both sides of the Mylar are treated with small glitter flakes 17 and a thin film (not shown) to prevent adjacent layers from catching. The lanyard 21 facilitates release of the roll to form a streamer.

The present invention may be embodied in still other specific forms without departing from its spirit or essential characteristics. The described embodiments are to be considered in all respects only as illustrative and not restrictive. The scope of the invention is, therefore, indicated by the appended claims rather than the foregoing description. All changes which come within the meaning and equivalency of the claims are to be embraced within their scope.

What is claimed is:

1. A method for use by a person in a distress situation to attract attention of rescuers comprising the step of spreading in the surrounding environment multiple particles of glitter material capable of reflecting sun rays or the rays from search lights.

2. The method of claim 1 in which the glitter material comprises flakes of reflective metal.

3. The method of claim 2 in which the glitter material comprises flakes of aluminum.

4. The method of claim 1 in which the glitter material comprises fragments of a base sheet material coated with a reflective surface coating material.

5. The method of claim 4 in which the base sheet material is coated with a pearlescent paint.

6. The method of claim 4 in which the base sheet material is coated with flakes of reflective metal.

7. The method of claim 4 in which the base sheet material coated with a reflective surface coating material is bonded to a floatable backing material.

8. The method of claim 7 in which the floatable backing material is a cellular material.

9. The method of claim 8 in which the cellular material is polyurethane foam.

10. The method of claim 4 in which the base sheet material is a polymer film.

11. The method of claim 4 in which the base sheet material is paper.

12. The method of claim 4 in which the base sheet material is a metal foil.

13. The method of claim 4 in which the base sheet material is cut in a long narrow shape to form a streamer.

14. The method of claim 13 in which the streamer is rolled for transport and storage.

15. The method of claim 14 in which a lanyard is attached to the end of the streamer in the middle of the roll for use in releasing the streamer.

16. An emergency kit containing as an essential component a bag of multiple particles of glitter material capable of reflecting sun rays or the rays from search lights.

17. The emergency kit of claim 16 in which the glitter material comprises flakes of reflective metal.

18. The emergency kit of claim 16 in which the glitter material comprises flakes of aluminum.

19. The emergency kit of claim 16 in which the glitter material comprises fragments of sheet material coated with a reflective surface coating material.

20. The emergency kit of claim 16 in which the sheet material is coated with a pearlescent paint.

21. The emergency kit of claim 19 in which the sheet material is coated with flakes of reflective metal.

22. The emergency kit of claim 19 in which the sheet material is cut into fragments having jagged edges.

23. The emergency kit of claim 19 in which the sheet material is coated on both sides with a reflective material.

24. The emergency kit of claim 19 in which the sheet material coated with a reflective surface coating material is bonded to a floatable backing material.

25. The emergency kit of claim 24 in which the floatable backing material is a cellular material.

26. The emergency kit of claim 25 in which the cellular material is polyurethane foam.

27. The emergency kit of claim 19 in which the sheet material is a polymer film.

28. An emergency rescue glitter material comprising fragments of a base sheet material coated with a reflective surface coating material, said fragments being bonded to a floatable backing material.

29. The rescue material of claim 28 in which the floatable backing material is a cellular material.

30. The rescue material of claim 28 in which the cellular material is polyurethane foam.

31. The rescue material of claim 28 in which the base sheet material is embossed to enhance the reflective characteristics thereof.

32. The rescue material of claim 28 in which the base sheet material is a polymer film.

33. A rescue material comprising a long, narrow streamer coated on its surface with a reflective coating material.

34. The rescue material of claim 33 in which said streamer is rolled up for transport and storage.

35. The rescue material of claim 34 in which a lanyard is attached to an end of said streamer in the middle of said roll, for use in releasing said streamer.
